(19) United States
(12) Patent Application Publication
(10) Pub. No.: US 2016/0048315 A1
(43) Pub. Date: Feb. 18, 2016

(54) USABILITY-CHECK-RESULT OUTPUT METHOD, DEVICE, AND PROGRAM

(71) Applicant: NEC SOLUTION INNOVATORS, LTD., Tokyo (JP)

(72) Inventors: Yusuke NAKAO, Tokyo (JP); Hisashi NODA, Tokyo (JP)

(21) Appl. No.: 14/778,736

(22) PCT Filed: Jan. 10, 2014
(86) PCT No.: PCT/JP2014/000084

§ 371 Date: Sep. 21, 2015

(30) Foreign Application Priority Data
Mar. 19, 2013 (JP) 2013-056650

(51) Int. Cl. G06F 3/0484

(52) U.S. Cl. CPC G06F 3/04847; G06F 3/04845; G06F 3/04842

(57) ABSTRACT

In this usability-check-result output method, screen information for a screen to be checked is obtained, said screen is checked on the basis of pre-stored checking rules, and if there are any categories in which the screen does not conform to the checking rules, the results of the check are displayed on the screen.

### TECHNICAL FIELD

The present invention relates to a usability-check-result output method for checking a user interface of a screen, a usability-check-result output device, and a usability-check-result output program.

### BACKGROUND ART

Developed user interfaces of screens such as WEB pages may be different in their qualities depending on developers, and thus need to be checked by experts. However, there is a problem that since a number of persons who can check are limited, check takes cost and time.

NPL 1 discloses therein a tool for automatically evaluating usability such as readability on WEB page screens or understandability of contents and extracting a problem to be improved.

NPL 2 discloses therein selenium as an automated tool for testing application software.

### CITATION LIST

### Non Patent Literature

NPL 1: Takehiro, SUZUKI, “An Automatic Usability Testing Method for web pages”, mater thesis, NARA INSTITUTE of SCIENCE and TECHNOLOGY, Feb. 14, 1999
NPL 2: “seleniumHQ”, [online], [searched on Feb. 28, 2013], Internet <URL: http://docs.seleniumhq.org/>

### SUMMARY OF INVENTION

### Technical Problem

However, check results by the tool described in NPL 1 are collectively displayed for all the screens. Therefore, there is a problem that correspondences between checked items and check results are difficult to understand.

It is therefore an object of the present invention to provide a usability-check-result output method capable of easily displaying correspondences between checked items and check results, a usability-check-result output device, and a usability-check-result output program.

### Solution to Problem

A usability-check-result output method according to the present invention is characterized by acquiring screen information on a screen to be checked, checking the screen based on a previously-stored check rule, and when an item not conforming to the check rule is present, displaying a check result on the screen.

A usability-check-result output device according to the present invention is characterized by including an input unit for acquiring screen information on a screen to be checked, a check unit for checking the screen based on a previously-stored check rule, and a display processing unit for, when an item not conforming to the check rule is present, displaying a check result on the screen.

A usability-check-result output program according to the present invention is characterized by causing a computer to perform an input processing of acquiring screen information on a screen to be checked, a check processing of checking the screen based on a previously-stored check rule, and a display processing of, when an item not conforming to the check rule is present, displaying a check result on the screen.

### Advantageous Effects of Invention

According to the present invention, it is possible to easily display correspondences between checked items and check results.

### BRIEF DESCRIPTION OF DRAWINGS

FIG. 1 It depicts a block diagram illustrating a structure of a usability-check-result output device according to a first exemplary embodiment of the present invention.

FIG. 2 It depicts a flowchart illustrating the operations of the usability-check-result output device according to the first exemplary embodiment of the present invention.

FIG. 3 It depicts an explanatory diagram illustrating an exemplary setting screen.

FIG. 4 It depicts an explanatory diagram illustrating an exemplary check rule.

FIG. 5 It depicts an explanatory diagram illustrating exemplary text boxes displayed on a screen.

FIG. 6 It depicts an explanatory diagram illustrating an exemplary screen displaying a check result thereon.

FIG. 7 It depicts an explanatory diagram illustrating another exemplary screen displaying a check result thereon.

FIG. 8 It depicts an explanatory diagram illustrating an exemplary screen displaying a minimized message box thereon.

FIG. 9 It depicts a block diagram illustrating a structure of a usability-check-result output device according to a second exemplary embodiment of the present invention.

FIG. 10 It depicts a flowchart of the operations of the usability-check-result output device according to the second exemplary embodiment of the present invention.

FIG. 11 It depicts an explanatory diagram illustrating an exemplary option setting screen.

FIG. 12 It depicts an explanatory diagram illustrating an exemplary check criterion setting screen.

FIG. 13 It depicts a block diagram illustrating a structure of a usability-check-result output device according to a third exemplary embodiment of the present invention.

FIG. 14 It depicts a flowchart of the operations of the usability-check-result output device according to the third exemplary embodiment of the present invention.

FIG. 15 It depicts an explanatory diagram illustrating an exemplary batch processing.

FIG. 16 It depicts an explanatory diagram illustrating another exemplary batch processing.

FIG. 17 It depicts a block diagram illustrating a structure of main components in a usability-check-result output device according to the present invention.

### DESCRIPTION OF EMBODIMENTS

### First Exemplary Embodiment

Exemplary embodiments of a usability-check-result output device according to the present invention will be described below with reference to the drawings.

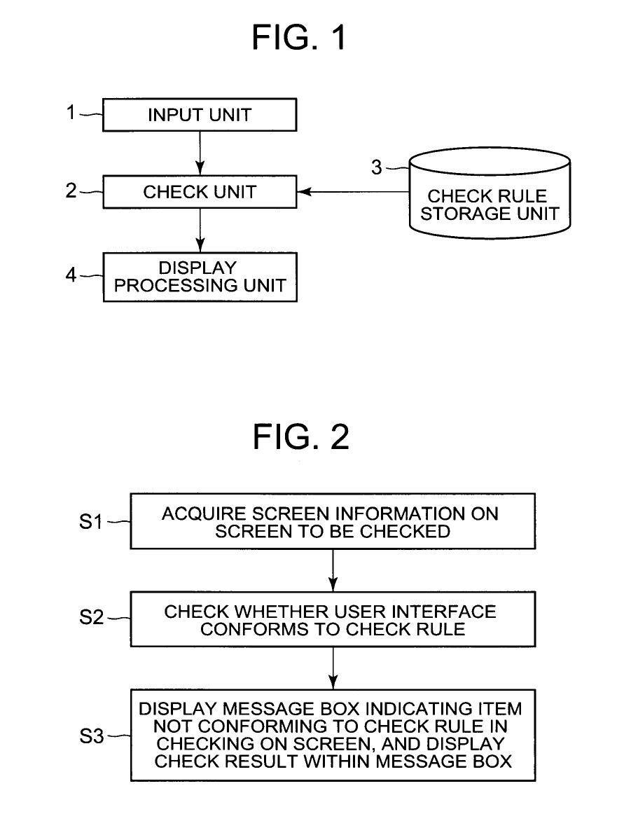

FIG. 1 is a block diagram illustrating a structure of a usability-check-result output device according to the present exemplary embodiment. As illustrated in FIG. 1, the usability-check-result output device according to the present exemplary embodiment includes an input unit 1, a check unit 2, a check rule storage unit 3, and a display processing unit 4. The input unit 1, the check unit 2, and the display processing unit 4 are realized in hardware designed to conduct a series of specific calculation processing, or by an information processing apparatus such as CPU (Central Processing Unit) operating according to a program, for example. The check rule storage unit 3 is realized by a storage device such as typical HDD (Hard Disk Drive).

The input unit 1 acquires screen information for defining a user interface of a screen to be checked. When the screen is a WEB page displayed on a typical browser, for example, the input unit 1 acquires a HTML (HyperText Markup Language) source as screen information. Further, the input unit 1 may acquire screen information such as coordinate information, color information and text information within a displayed screen from the browser, for example. Any other screens displaying a user interface thereon, not limited to WEB pages, may be to be checked.

The check unit 2 acquires a check rule from the check rule storage unit 3, and checks whether the screen information acquired from the input unit 1 conforms to the check rule.

The check rule storage unit 3 stores therein the check rules for checking a user interface of a screen. The check rules are based on consistency of display and operations, and viewability of information or the like, that are previously stored by a designer or the like. The check rule storage unit 3 stores error messages, supplementary messages, coping methods, and the like associated with the check rules, respectively. The check rules may be described in a program for causing the CPU to perform the operations of the check unit 2, and in this case, the check rule storage unit 3 is dispensable.

The display processing unit 4 displays a message box indicating an item not conforming to a check rule in the checking on the screen of a display device or the like, and displays a check result within the message box. The check result is an error message stored in the check rule storage unit 3, for example. The display processing unit 4 has only to display a check result on the screen including an item not conforming to a check rule in the checking, and may not necessarily use a message box indicating the item to be displayed.

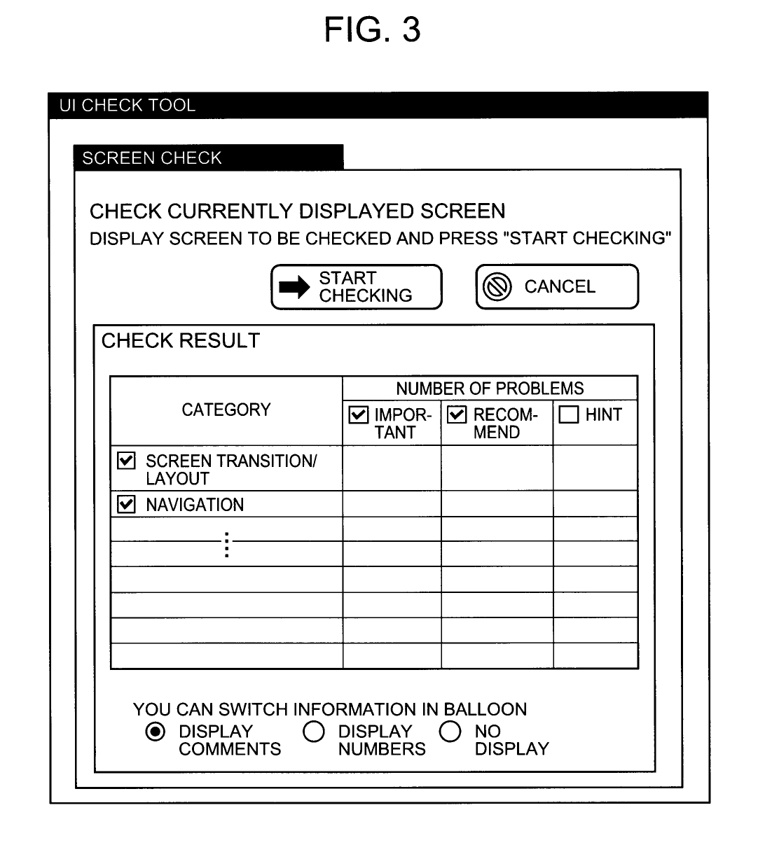

The operations of the usability-check-result output device according to the present exemplary embodiment will be described below. FIG. 2 is a flowchart illustrating the operations of the usability-check-result output device according to the present exemplary embodiment. At first, the user sends an instruction to cause the usability-check-result output device to start checking. At this time, the display processing unit 4 may display a setting screen enabling the user to perform detailed setting for the checking. FIG. 3 is an explanatory diagram illustrating an exemplary setting screen. Specifically, the user selects a category to be checked and presses a check start button on the setting screen as illustrated in FIG. 3, for example.

The setting screen is configured such that the user can select contents to be checked depending on a degree of importance. In the example illustrated in FIG. 3, the user can select one of three types “important”, “recommend”, and “hint.” Further, the setting screen may be configured such that the user can select a type of rule to be checked. Further, as illustrated in FIG. 3, there may be configured such that when the checking described later is completed, the number of problems (the number of items not conforming to check rules) is displayed. The setting screen is configured such that the user can switch a check result display method. In the example illustrated in FIG. 3, the user can select a display method from among three types “display comments”, “display numbers”, and “no display.”

When being sent an instruction to start checking from the user, the input unit 1 acquires the screen information for defining a user interface of the screen to be checked (step S1). When the screen is a WEB page to be displayed on a typical browser, the input unit 1 acquires a HTML source. Further, the input unit 1 may acquire coordinate information, color information, and text information within the screen from the browser, for example. Both or either one of a method for acquiring screen information from a HTML source and a method for acquiring screen information from a browser may be employed.

The input unit 1 employs a typical script language function such as javascript (registered trademark) in order to acquire screen information such as coordinate information, color information, and text information within the screen. The input unit 1 can also acquire information which cannot be acquired from a HTML source or the like, such as distance between text and button and size of radio button by acquiring the screen information from the browser.

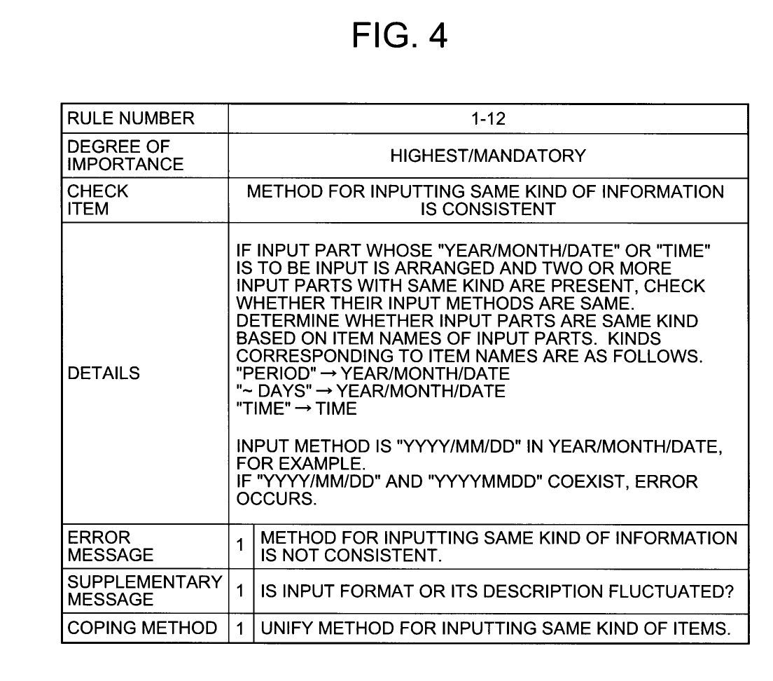

The check unit 2 acquires a check rule from the check rule storage unit 3, and checks whether the screen information acquired from the input unit 1 conforms to the check rule (step S2). FIG. 4 is an explanatory diagram illustrating an exemplary check rule. Design contents of a check rule include rule number, degree of importance, check item, error message, supplementary message, and coping method in addition to details of the check rule as illustrated in FIG. 4.

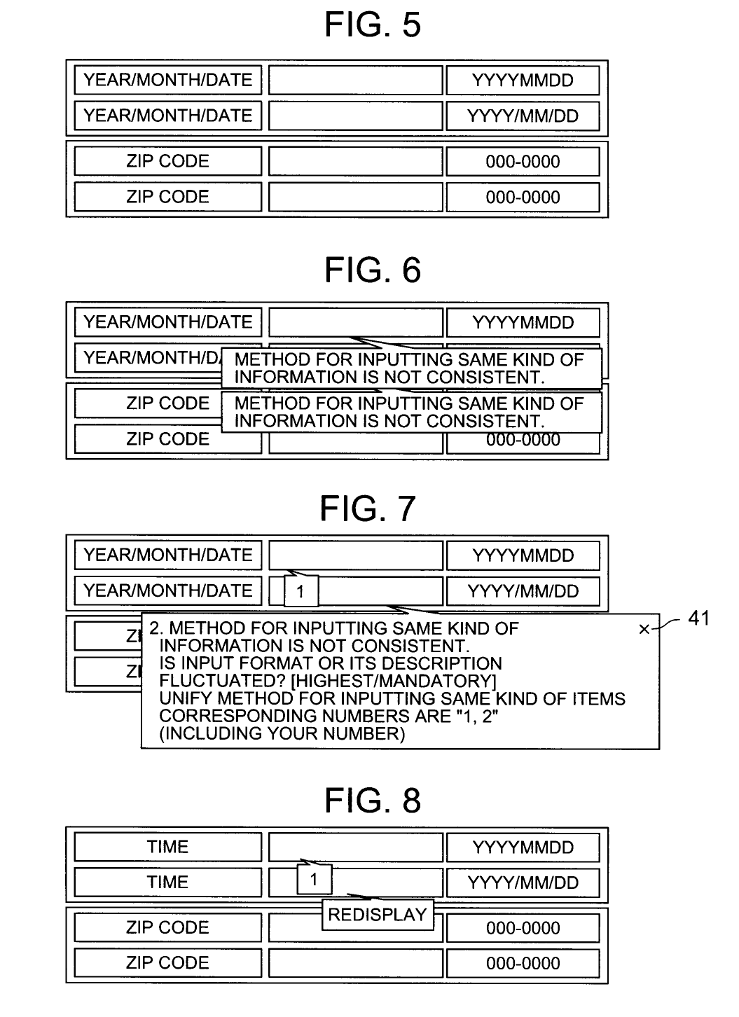

For example, when checking by use of the check rule illustrated in FIG. 4, the check unit 2 checks whether a method for inputting the same kind of information is consistent. FIG. 5 is an explanatory diagram illustrating an exemplary text box displayed on the screen. In FIG. 5, “YYYY/MM/DD” and “YYYYMMDD” coexist as a year/month/date input method. Therefore, the check unit 2 determines an error based on the check rule illustrated in FIG. 4.

The display processing unit 4 displays a message box indicating an item not conforming to the check rule in the checking on the screen of the display device or the like, and displays a check result within the message box (step S3). The check result is an error message stored in association with the check rule in the check rule storage unit 3, for example. The display processing unit 4 uses coordinate information or the like on the screen acquired by the input unit 1 in order to determine a display position of the message box.

FIG. 6 is an explanatory diagram illustrating an exemplary screen displaying a check result thereon. As illustrated in FIG. 6, the display processing unit 4 displays a message box indicating an item not conforming to the check rule in the checking, and displays an error message stored in the check rule storage unit 3. In this way, the error message is displayed to indicate the item involved immediately near the item, and thus the user can more easily recognize the item involved than when the error message is displayed in a list.

FIG. 7 is an explanatory diagram illustrating another exemplary screen displaying a check result thereon. When the user places the mouse pointer on the message box illustrated in FIG. 6, the display processing unit 4 displays detailed contents within the message box. For example, the display processing unit 4 displays the detailed contents including a supplementary message and a coping method within the message box. The display processing unit 4 may display the supplementary message and the coping method within the message box from the beginning, but preferably displays the supplementary message and the coping method only when the mouse pointer is placed on the message box because other items and the like are hidden.

When the mouse pointer is placed on the message box, the display processing unit 4 may transmit other message boxes except a relevant message box. Thereby, only the message boxes relevant to a message box selected by the user can be emphasized.

When a relevant message is displayed as illustrated in FIG. 7, the display processing unit 4 displays only a number in one message box, and may not display the message. For example, FIG. 6 indicates that the year/month/date display method is not consistent between two items, and thus only a number (“1” in FIG. 7) is displayed in one item. A description indicating a relevant number (a description that “corresponding numbers are “1” and “2”” in FIG. 7) is displayed in the message box indicating the other item. When all the relevant messages are displayed, other items and the like are hidden, and thus the display processing unit 4 can minimize range of other items and the like to be hidden by displaying only the numbers for the relevant items.

Further, the display processing unit 4 may display a message box in a color depending on a degree of importance of a check rule. For example, the display processing unit 4 displays an item with a high degree of importance in an eye-catching color such as red. Thereby, the use can easily find the message for the check rule with a high degree of importance.

When the mouse pointer is placed on the message box, the display processing unit 4 may display surrounding the item having a problem in a red frame. Thereby, the item having a problem can be emphasized for display.

Further, the display processing unit 4 may display a list of check results and may give the links to corresponding screens in the list. With the display method, the user can select and display only a part which he/she wants to particularly confirm in the list of check results.

The display processing unit 4 may display a minimizing button 41 within a message box as illustrated in FIG. 7. When wanting to minimize a message box, the user presses the minimizing button 41. FIG. 8 is an explanatory diagram illustrating an exemplary screen displaying a minimized message box thereon. As illustrated in FIG. 8, the message box is minimized so that the user can refer to the items on the background. As illustrated in FIG. 8, the minimized message box may be transmissive. Further, “redisplay” is described in the minimized message box, and when the user clicks the message box, the message illustrated in FIG. 7 is redisplayed.

With the usability-check-result output device according to the present exemplary embodiment, an error message indicating an items having a problem is displayed immediately near the item, and thus the user can more easily confirm the item having a problem than when a list of error messages is displayed.

### Second Exemplary Embodiment

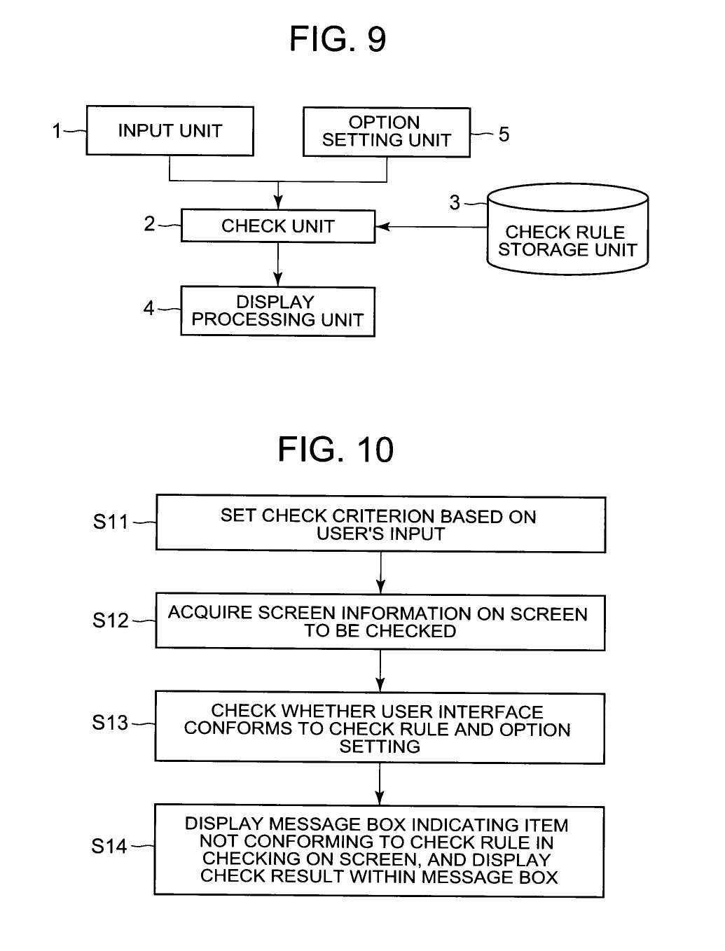

FIG. 9 is a block diagram illustrating a structure of a usability-check-result output device according to a second exemplary embodiment. In FIG. 9, the functions of the input unit 1, the check rule storage unit 3, and the display processing unit 4 are the same as those in the first exemplary embodiment, and thus the description thereof will be omitted.

An option setting unit 5 sets a check criterion based on user's selection. The option setting unit 5 sets a reference screen based on user's selection, for example. In this case, the check unit 2 checks by comparing other screen with the reference screen. The option setting unit 5 may set a detailed check criterion based on user's input.

The check unit 2 acquires a check rule from the check rule storage unit 3, and acquires setting contents from the option setting unit 5. The check unit 2 checks whether the screen information acquired from the input unit 1 conforms to the check rule and the check criterion set by the option setting unit 5.

The operations of the usability-check-result output device according to the second exemplary embodiment will be described below. FIG. 10 is a flowchart illustrating the operations of the usability-check-result output device according to the second exemplary embodiment.

The option setting unit 5 displays an option setting screen for receiving option setting for the checking, and sets a check criterion based on user's input (step S11). The option setting unit 5 sets a reference screen based on user's selection, for example. In this case, the check unit 2 checks by comparing other screen with the reference screen. Further, the option setting unit 5 may set a detailed check criterion based on user's input.

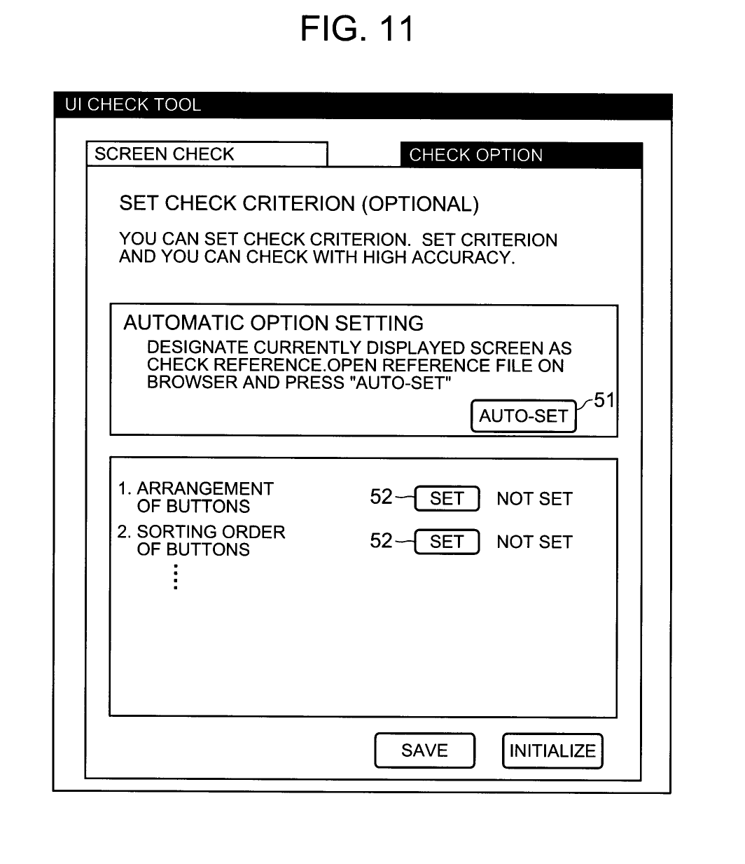

FIG. 11 is an explanatory diagram illustrating an exemplary option setting screen. The user determines a reference screen, and when he/she wants to check by comparing other screen with the reference screen, he/she presses an automatic setting button 51 while the reference screen is being displayed. Further, when wanting to set contents to be checked, the user presses a setting button 52 of a desired item.

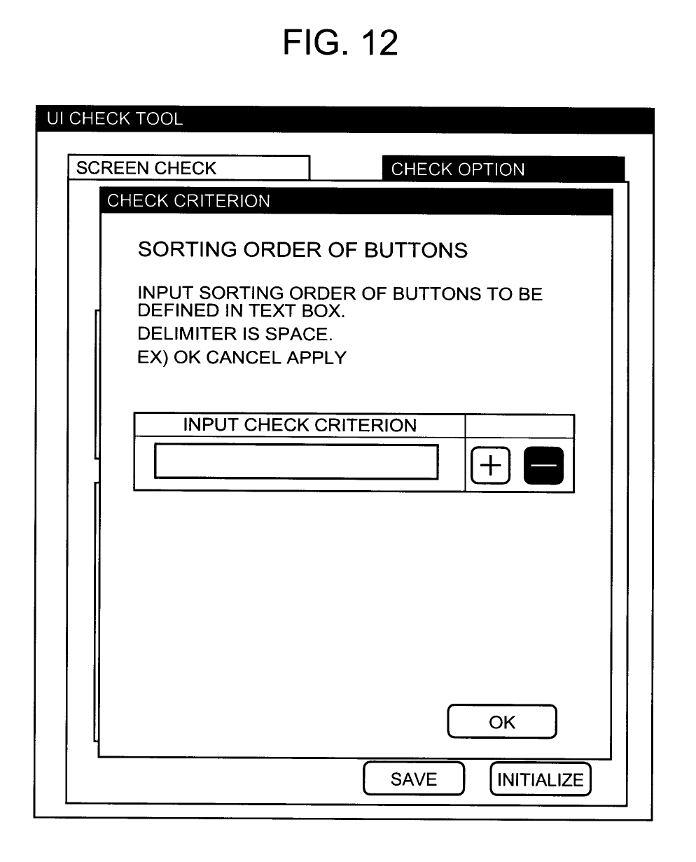

FIG. 12 is an explanatory diagram illustrating an exemplary check criterion setting screen. FIG. 12 illustrates a screen displayed when the setting button 52 in the sorting order of buttons is pressed in FIG. 11. For example, when three buttons with the button names of “OK”, “cancel”, and “apply” are present, for example, the user inputs the button names into the text box in an order in which he/she wants to arrange.

The input unit 1 acquires screen information for defining a user interface of a screen to be checked (step S12). The processing in step S12 is the same as the processing in step S1 in FIG. 2.

The check unit 2 acquires a check rule from the check rule storage unit 3, and acquires setting contents from the option setting unit 5. The check unit 2 checks whether the screen information acquired from the input unit 1 conforms to the check rule and the check criterion set by the option setting unit 5 (step S13).

For example, when checking by comparing other screen with the reference screen, the check unit 2 compares a screen to be checked with the reference screen with respect to the check items such as button position, text contents, and color of background or characters. Further, when the user sets a check criterion in detail, the check unit 2 checks the screen based on the criterion.

The display processing unit 4 displays a message box indicating an item not conforming to the check rule in the checking on the screen, and displays a check result within the message box (step S14). The processing in step S14 is the same as the processing in step S3 in FIG. 2.

With the usability-check-result output device according to the present exemplary embodiment, the user can freely customize a check method, thereby checking a screen at user's will.

### Third Exemplary Embodiment

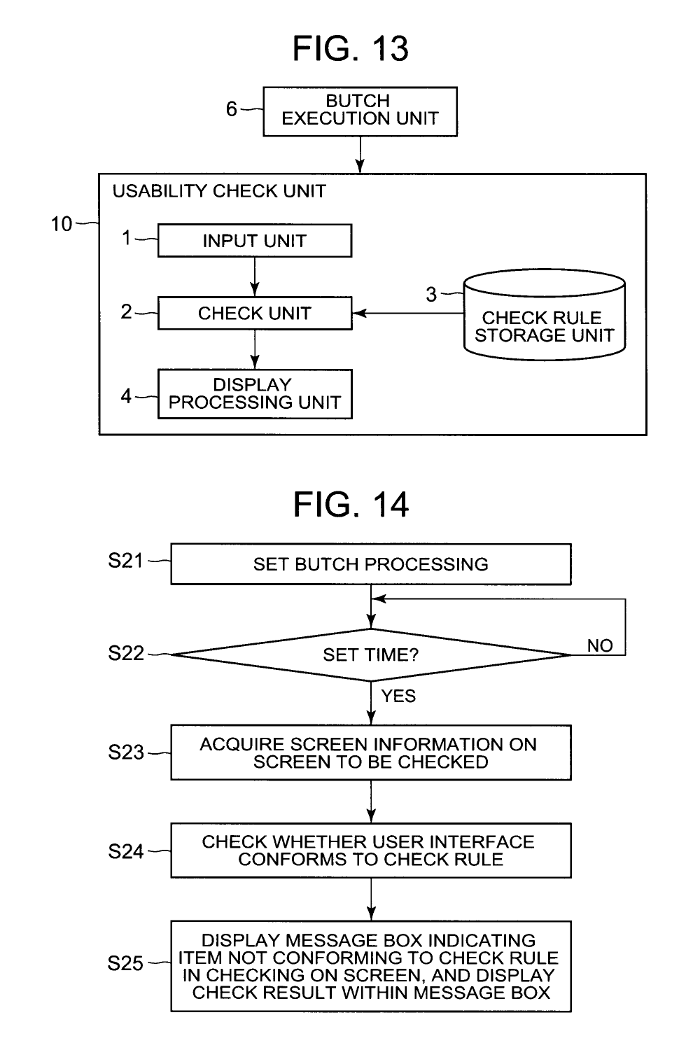

FIG. 13 is a block diagram illustrating a structure of a usability-check-result output device according to a third exemplary embodiment. As illustrated in FIG. 13, the usability-check-result output device according to the present exemplary embodiment includes a batch execution unit 6 and a usability check unit 10. A structure of the usability check unit 10 is the same as the structure described according to the first exemplary embodiment, and thus the description thereof will be omitted.

The batch execution unit 6 causes the usability check unit 10 to perform a processing on a file describing therein a program for realizing a screen to be checked. The batch execution unit 6 causes the usability check unit 10 to perform a processing on screen information described in a source file such as HTML. Alternatively, the batch execution unit 6 may automatically display a screen to be checked, may cause the operations such as login and text input to be automatically performed, and may cause the usability check unit 10 to perform a processing on the screen.

The operations of the usability-check-result output device according to the present exemplary embodiment will be described below. FIG. 14 is a flowchart illustrating the operations of the usability-check-result output device according to the present exemplary embodiment. The series of processing in step S23 to step S25 are the same as the series of processing in step S1 to step S3 according to the first exemplary embodiment, and thus the specific description thereof will be omitted.

At first, the user sets for the batch processing (step S21). Specifically, the user sets where a program file (such as HTML) for realizing a screen to be checked is to be stored. Further, the user sets a time to perform the batch processing.

When a preset time comes (YES in step S22), the batch execution unit 6 causes the usability check unit 10 to perform a processing on the program file for realizing a screen to be checked (step S23 to step S25).

### EXAMPLES

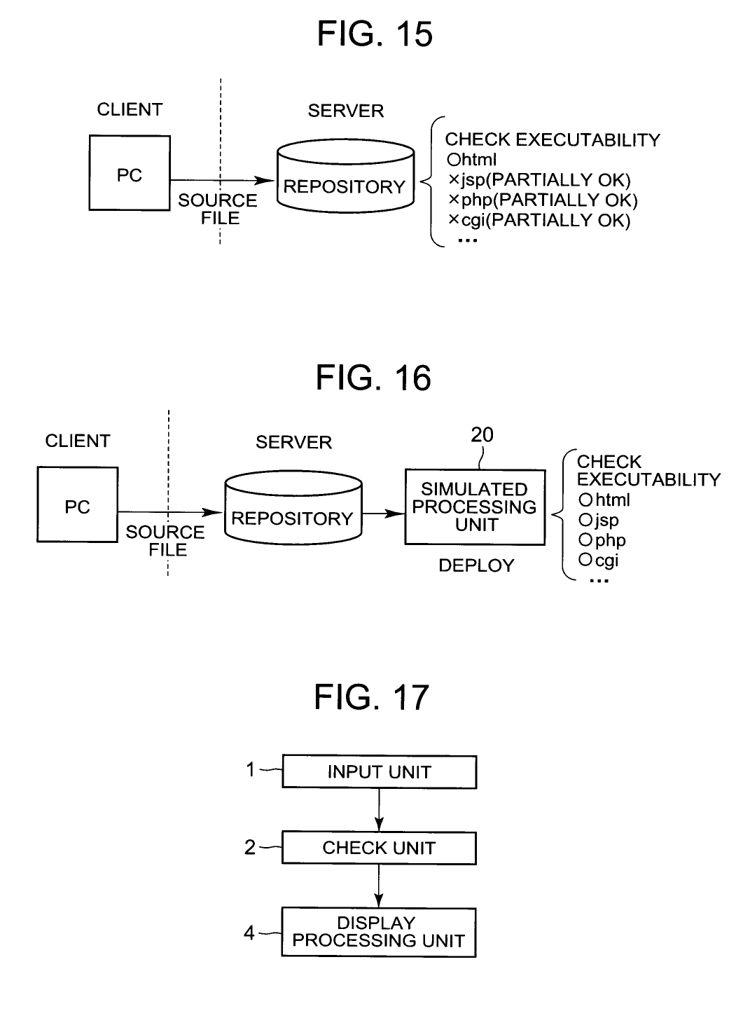

FIG. 15 is an explanatory diagram illustrating an exemplary batch processing. The user stores a source file such as HTML in a repository in a server from a client PC (Personal computer). When a preset time comes, the batch execution unit 6 then causes the usability check unit 10 to perform a processing on the program file for realizing a screen to be checked. In the example illustrated in FIG. 15, the check unit 2 checks by use of only a source file without actually displaying a screen, and thus executable program files are limited. For example, the checking by the check unit 2 can be performed on HTML but cannot be partially performed on jsp, php, cgi, and the like.

FIG. 16 is an explanatory diagram illustrating another exemplary batch processing. The user stores a source file such as HTML in a repository in a server from a client PC. When a preset time comes, the batch execution unit 6 then causes a simulated processing unit 20 in the server to deploy a screen to be checked. An automated test tool disclosed in NPL 2 is employed for deploy, for example. Specifically, the simulated processing unit 20 in the server automatically displays a screen to be checked, and automatically performs the operations such as login and text input. The batch execution unit 6 then causes the usability check unit 10 to perform a processing by use of the program file for realizing a screen to be checked and the screen information acquired from the displayed screen.

In the example illustrated in FIG. 16, the screen is actually displayed to be checked, and thus the check unit 2 can check all the screens like when the user manually checks.

The usability check unit 10 according to the present exemplary embodiment may include the option setting unit 5 described according to the second exemplary embodiment. In this case, the user performs option setting prior to batch execution.

With the usability-check-result output device according to the present exemplary embodiment, for example, when the user sets the batch processing to be performed during nighttime every day, he/she can easily know problematic points on daily-varying screens in a developing stage. Further, with the usability-check-result output device according to the present exemplary embodiment, the user can omit his/her own checking.

FIG. 17 is a block diagram illustrating a structure of main components in a usability-check-result output device according to the present invention. The usability-check-result output device according to the present invention includes the input unit 1 for acquiring screen information on a screen to be checked, the check unit 2 for checking the screen based on a previously-stored check rule, and the display processing unit 4 for displaying a check result on the screen when an item not conforming to the check rule is present.

Each exemplary embodiment discloses the usability-check-result output device described in the following (1) to (5).

(1) A usability-check-result output device in which a display processing unit (the display processing unit 4, for example) displays a message box indicating an item not conforming to a check rule on a screen, and displays first text information (such as error message) as a check result within the message box. With the usability-check-result output device, the user can easily confirm an item involved.

(2) The usability-check-result output device may be configured such that when a mouse pointer is placed on a message box, the display processing unit displays second text information (such as supplementary message and coping method) indicating a more detailed check result than first text information within the message box. With the usability-check-result output device, the user can display a supplementary message, a coping method, and the like as needed.

(3) The usability-check-result output device may be configured such that the display processing unit displays a message box in a different color depending on a degree of importance of a check rule. With the usability-check-result output device, the user can easily find a message for a check rule with a high degree of importance.

(4) The usability-check-result output device may include an option setting unit (the option setting unit 5, for example) for setting a check criterion based on user's selection, in which the check unit checks screen information based on a check rule and the check criterion. With the usability-check-result output device, the user can freely customize a check method, thereby checking a screen at user's will.

(5) The usability-check-result output device may include a batch execution unit (the batch execution unit 6, for example) for setting a time to perform a batch processing, and when the set time comes, causing the input unit, the check unit, and the display processing unit to perform a series of processing. With the usability-check-result output device, the user can omit his/her own checking.

The present application claims the priority based on Japanese Application No. 2013-056650 filed on Mar. 19, 2013, the disclosure of which is all incorporated herein by reference.

The present invention has been described above by way of the exemplary embodiments and the example, but the present invention is not limited to the exemplary embodiments and the example. The structure and details of the present invention can be variously modified within the scope of the present invention understandable by those skilled in the art.

### INDUSTRIAL APPLICABILITY

The present invention is applicable to check usability of a user interface of a WEB site.

### REFERENCE SIGNS LIST

1 Input unit
2 Check unit
3 Check rule storage unit
4 Display processing unit
5 Option setting unit
6 Butch execution unit

1. A usability-check-result output method comprising:
acquiring screen information on a screen to be checked;
checking the screen based on a previously-stored check rule; and
when an item not conforming to the check rule is present, displaying a check result on the screen.

2. The usability-check-result output method according to claim 1, comprising:
displaying a message box indicating an item not conforming to a check rule on the screen and displaying first text information as a check result within the message box.

3. The usability-check-result output method according to claim 2, comprising:
when a mouse pointer is placed on a message box, displaying second text information indicating a more detailed check result than first text information within the message box.

4. The usability-check-result output method according to claim 2, comprising:
displaying a message box in a different color depending on a degree of importance of a check rule.

5. The usability-check-result output method according to claim 1, comprising:
setting a check criterion based on user's selection; and
checking screen information based on a check rule and the check criterion.

6. The usability-check-result output method according to claim 1, comprising:
storing a set time to perform a batch processing, and when the set time comes, performing a screen information acquisition processing, a screen check processing, and a check result display processing.

7. A usability-check-result output device comprising:
an input unit for acquiring screen information on a screen to be checked;
a check unit for checking the screen based on a previously-stored check rule; and
a display processing unit for, when an item not conforming to the check rule is present, displaying a check result on the screen.

8. The usability-check-result output device according to claim 7,
wherein the display processing unit displays a message box indicating an item not conforming to a check rule on the screen, and displays first text information as a check result within the message box.

9. A non-transitory computer readable information recording medium storing a usability-check-result output program that, when executed by a processor, performs a method for:
acquiring screen information on a screen to be checked;
checking the screen based on a previously-stored check rule; and
when an item not conforming to the check rule is present, displaying a check result on the screen.

10. The non-transitory computer readable information recording medium storing a usability-check-result output program according to claim 9, the program that, when executed by a processor, performs a method for:
displaying a message box indicating an item not conforming to a check rule on the screen and displaying first text information as a check result within the message box.

11. The usability-check-result output method according to claim 3, comprising:
displaying a message box in a different color depending on a degree of importance of a check rule.

12. The usability-check-result output method according to claim 2, comprising:
setting a check criterion based on user's selection; and
checking screen information based on a check rule and the check criterion.

13. The usability-check-result output method according to claim 3, comprising:
setting a check criterion based on user's selection; and
checking screen information based on a check rule and the check criterion.

14. The usability-check-result output method according to claim 4, comprising:
setting a check criterion based on user's selection; and
checking screen information based on a check rule and the check criterion.

15. The usability-check-result output method according to claim 2, comprising:
storing a set time to perform a batch processing, and when the set time comes, performing a screen information acquisition processing, a screen check processing, and a check result display processing.

16. The usability-check-result output method according to claim 3, comprising:
storing a set time to perform a batch processing, and when the set time comes, performing a screen information acquisition processing, a screen check processing, and a check result display processing.

17. The usability-check-result output method according to claim 4, comprising:
storing a set time to perform a batch processing, and when the set time comes, performing a screen information acquisition processing, a screen check processing, and a check result display processing.

18. The usability-check-result output method according to claim 5, comprising:
storing a set time to perform a batch processing, and when the set time comes, performing a screen information acquisition processing, a screen check processing, and a check result display processing.

19. The usability-check-result output method according to claim 13, comprising:
storing a set time to perform a batch processing, and when the set time comes, performing a screen information acquisition processing, a screen check processing, and a check result display processing.

20. The usability-check-result output method according to claim 14, comprising:
storing a set time to perform a batch processing, and when the set time comes, performing a screen information acquisition processing, a screen check processing, and a check result display processing.
